(19) United States
(12) Patent Application Publication
(10) Pub. No.: US 2016/0210955 A1
(43) Pub. Date: Jul. 21, 2016

(54) ACOUSTIC PANEL

(71) Applicants: CENTRE NATIONAL DE LA RECHERCHE SCIENTIFIQUE, Paris Cedex 16 (FR); UNIVERSITE DU MAINE, Le Mans Cedex 9 (FR); SUPMECA, Saint Ouen Cedex (FR)

(72) Inventors: Clement Lagarrigue, Le Mans (FR); Jean-Philippe Groby, Le Mans (FR); Vincent Tournat, Beaufay (FR); Olivier Dazel, Le Mans (FR); Benoit Nennig, Paris (FR)

(73) Assignees: CENTRE NATIONAL DE LA RECHERCHE SCIENTIFIQUE, PARIS (FR); UNIVERSITE DU MAINE, LE MANS (FR); SUPMECA, SAINT OUEN (FR)

(21) Appl. No.: 14/915,486

(22) PCT Filed: Aug. 29, 2014
(86) PCT No.: PCT/FR2014/052149

§ 371 Date: Feb. 29, 2016

(30) Foreign Application Priority Data
Aug. 29, 2013 (FR) 1358261

(51) Int. Cl. G10K 11/172

(52) U.S. Cl. CPC G10K 11/172

(57) ABSTRACT

The invention relates to an acoustically absorbent cell (22, 48) for an acoustic panel, comprising a layer (32) with a porous matrix incorporating a plurality of acoustic resonators (A₁-A₄, B₁-B₆) between a first face (30, 54) and a second face (28, 56) of the porous matrix (32). According to the invention, the resonators (A₁-A₄, B₁-B₆) are for example ordered so as to form at least two substantially parallel rows (24, 26, 50, 52) each comprising at least two resonators and extending along the first and second faces.

The present invention relates to an absorbent acoustic cell as well as an absorbent acoustic panel comprising a plurality of cells.

At the present time, the materials used for acoustic absorption are mainly materials with a porous matrix such as so-called porous materials (polyurethane foam, etc.) or so-called fibrous materials (glass wool, palm fibre, etc.). It is easy to integrate these materials into acoustic panels. In addition, the panel thus obtained is lightweight and has good acoustic attenuation in a major part of the frequencies of the audible spectrum.

However, these materials do not afford good attenuation in very low frequency sounds, that is to say for frequencies of around 50 Hz to 1000 Hz with thin panels with a thickness of around 5 to 10 cm, corresponding for example to the noise emitted by an engine ticking over. This is particularly true for frequencies where the corresponding wavelength is greater than four times the thickness of the material.

To overcome this problem, the solution commonly adopted consists of increasing the thickness and mass of the porous matrix by combining layers of different porous materials. The main drawback lies in greater size and mass of the acoustic panel.

Studies, in particular that of Groby et al. “Enhancing the absorption coefficient of a backed rigid frame porous layer by embedding circular periodic inclusions” (JASA, 130(6): 3771, 2011), have shown that the use of resonators such as split rings or Helmholtz resonators arranged in a layer of porous material made it possible to significantly absorb the low-frequency sounds incident on such a structure.

These structures thus significantly increase acoustic absorption. The physical phenomena have been revealed in several scientific publications, such as the article by Allard and Atalla “Propagation of sound in porous media: modelling sound absorbing materials” (Chapter 5, page 85, Wiley, 2009) with regard to the acoustic behaviour of a porous material, and in the scientific article by Groby et al. cited above with regard to the behaviour of the resonators included in the porous matrix.

Thus these structures make it possible to attenuate the acoustic energy through viscous and thermal losses. The resonators integrated in the porous matrix act as diffusers, reflecting the incident acoustic wave in all directions. Some of the acoustic energy is also absorbed because of the resonance of the resonators at their resonant frequency that depends on the dimensional characteristics of the resonator.

However, at the present time, though the efficacy of such a cell had been demonstrated, no particular industrially applicable geometry has yet been proposed. This is because the aforementioned studies were limited to demonstrating the advantage of a porous-matrix cell integrating a resonator. In addition, though the coefficient of absorption with such a cell is greater over the entire range of low frequencies up to 6000 Hz, it is greater than 0.8 only for frequencies above 2500 Hz and is less than 0.5 for very low frequencies below 1700 Hz.

In the scientific publications “Absorption of a rigid frame porous layer with periodic inclusions backed by a periodic grating”, JASA, 129(5), May 2011, and “Enhancing the absorption coefficient of a backed rigid frame porous layer by embedding circular periodic inclusions”, JASA, 130(6), December 2011, Groby et al. propose a numerical model comprising a layer of porous material comprising infinitely rigid cylinders, the arrangement of which makes it possible to form a diffraction grating. The cylinders used in the numerical model are cylinders defined numerically as infinitely rigid so that they cannot be assimilated to acoustic resonators.

The aim of the invention is in particular to afford a simple, effective and economical solution to these problems.

To this end, it proposes an acoustically absorbent cell for an acoustic panel, comprising a layer with a porous matrix incorporating a plurality of acoustic resonators between a first face and a second face of the porous matrix, characterised in that the resonators are ordered so that, in a direction extending substantially perpendicular to the first face and the second face, at least one first resonator is arranged between the first face and at least one second resonator is arranged between the second face and the at least one first resonator.

The invention thus proposes a particular arrangement of acoustic resonators inside a porous matrix. Integrating in the cell at least two resonators arranged one behind the other in a direction perpendicular to the first and second faces of the cell makes it possible to achieve very good absorption of low-frequency sounds both by absorption of the acoustic waves at the resonant frequencies of the resonators and by diffusion of the incident acoustic waves in all directions on the external surface of each resonator because of the use of two rows of resonators increasing the degree of reflection and therefore the coefficient of absorption of the cell.

Preferentially, the porous material is of the so-called open pore type, that is to say, when the material is filled with air, the air can circulate between the pores.

According to another feature of the invention, the dimensional parameters of the resonators are determined so that the resonators are all different in pairs.

The integration in a cell of a plurality of resonators all different in pairs through their dimensional parameters makes it possible to ensure absorption of each resonator at a different resonant frequency. It is desirable for these various resonant frequencies to be sufficiently close to one another in order to have a sufficiently great partial overlap of the frequency bands each associated with a resonance peak of a resonator so as to maintain the coefficient of absorption of the cell sufficiently high over a wide range of frequencies. This is achieved by choosing the dimensions of the resonators in a suitable manner.

Preferentially, the distances separating two resonators are all different in pairs. This particular arrangement of the resonators makes it possible to increase the destructive interferences between two given resonators, which increases the coefficient of absorption of the cell.

According to another feature of the invention, the first face comprises a layer of a rigid material having for example a Young's modulus of at least 20 GPa.

The layer of rigid material forms a wall of the cell beyond which the incident acoustic waves are not transmitted. This rigid layer may serve for attachment to a support intended for fixing the cell to an acoustic panel. The thickness of the layer is determined so that the incident acoustic waves can be reflected on this layer.

Advantageously, the first face is conformed so as to comprise at least one indentation forming a cavity extending in a direction opposite to the second face and emerging between the first and second faces.

Adding cavities on one of the faces of the cell makes it possible to absorb sounds at low frequencies that are determined by the thickness, that is to say the dimension of the cavities in a direction transverse to the first face and the second face. The resonant wavelength of each cavity corresponds to one quarter of the depth of each cavity.

In practice, in order to avoid excessively increasing the total thickness of an acoustic panel comprising a plurality of cells according to the invention arranged side by side, it is desirable for the cavities each to have a thickness of between 5 mm and 20 mm. Thus the thicknesses of the cavities are determined so that the quarter-wave resonant frequencies are between the frequencies of the resonators, the dimensions of which are determined so as to be between 500 and 1500 Hz and the frequencies of absorption of the porous matrix between 2500 and 6000 Hz.

It should be noted that, with cavities, the best absorption results are obtained with two resonators exactly arranged one behind the other in the direction perpendicular to the first and second faces. This is because the use of three layers or thicknesses of resonators with cavities does not allow the acoustic waves to reach the cavities because of the multiple reflections on the external surfaces of the resonators, acting on the path of the acoustic waves. Reducing the diameter of the resonators, in order to reduce the reflections and to allow a greater quantity of acoustic waves to reach the cavities, is not desirable since this would involve an increase in the resonant frequencies of the resonators.

According to another feature of the invention, the second face is substantially planar and the cavity or cavities have a rectangular or square cross-section.

In a practical embodiment of the invention, the resonators each comprise at least one opening making a resonant cavity of the resonator communicate with the porous matrix surrounding the resonator. The opening of at least one of said at least one first resonator emerges in the opening of a cavity on the first face.

This particular arrangement, that is to say the assembly formed from said resonator the opening of which emerges in the direction of the cavity, makes it possible to create an interaction between the resonator and the cavity. This is because simulations have shown that the assembly formed by the resonator and the cavity behaved as a resonator at a lower frequency than each of the respective frequencies of the resonator and cavity, which makes it possible to absorb lower frequencies without having to use a more bulky resonator, which would require increasing the thickness of the layer of the porous matrix, that is to say the distance between the first and second faces of the cell.

Preferentially, the resonators each have an elongate shape in a given direction extending along the first and second faces of the cell.

The directions of elongation of the resonators are preferentially substantially parallel to one another.

The resonators may be chosen from one or more of the types of resonator in the group comprising split tubes open at their ends and with a square, rectangular, circular, ellipsoidal or star-shaped cross-section, or Helmholtz resonators comprising at least one tubular neck emerging inside a cavity of the resonator.

In a possible embodiment of the cell according to the invention, the resonators are all of the same type.

In a practical embodiment of the invention, the resonators are all tubes with a circular cross-section, split over their entire height.

The cell may comprise two first resonators forming a first row arranged between the first face and at least two second resonators forming a second row that is arranged between the first row of first resonators and the second face.

According to the invention, the first row and second row may each comprise at least three resonators.

The invention further relates to an acoustically absorbent panel, characterised in that it comprises a plurality of cells as described above, the cells being arranged alongside one another so that the edges of the first faces of the cells are arranged opposite and the edges of the second faces of the cells are arranged opposite.

The panel may comprise five cells and preferentially ten.

The invention will be better understood and other details, advantages and features of the invention will emerge from a reading of the following description given by way of non-limitative example, with reference to the accompanying drawings, in which:

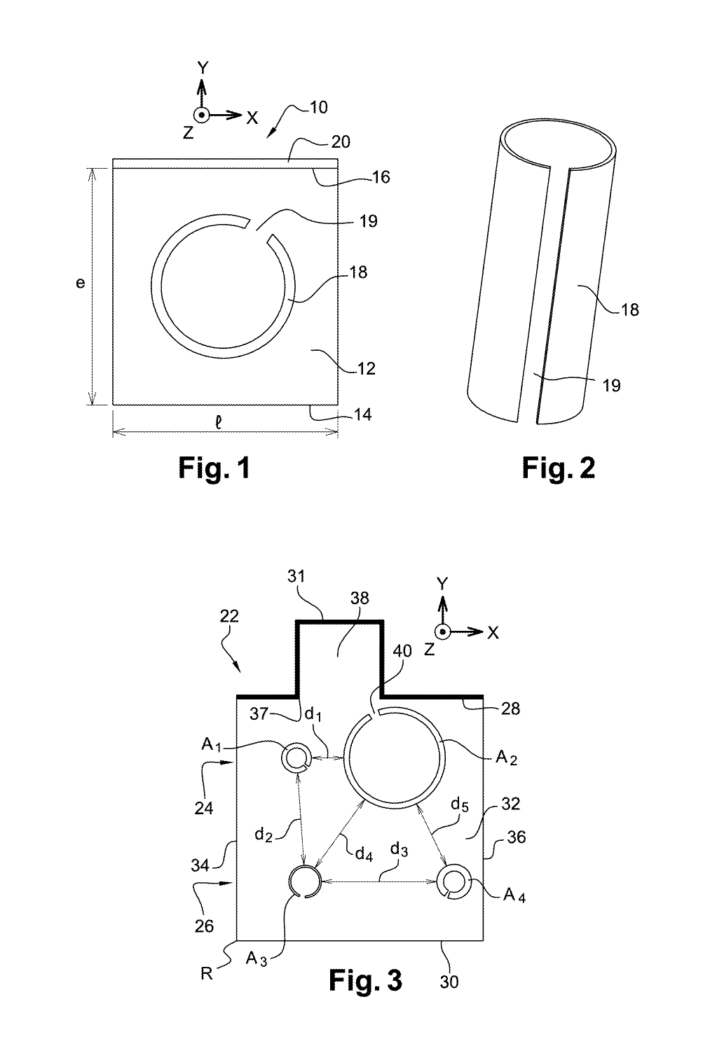

FIG. 1 is a schematic view in cross-section of an acoustically absorbent cell according to the known art;

FIG. 2 is a schematic perspective view of the resonator of the cell of FIG. 1;

FIG. 3 is a schematic view in cross-section of an acoustic absorbent cell according to a first embodiment of the invention;

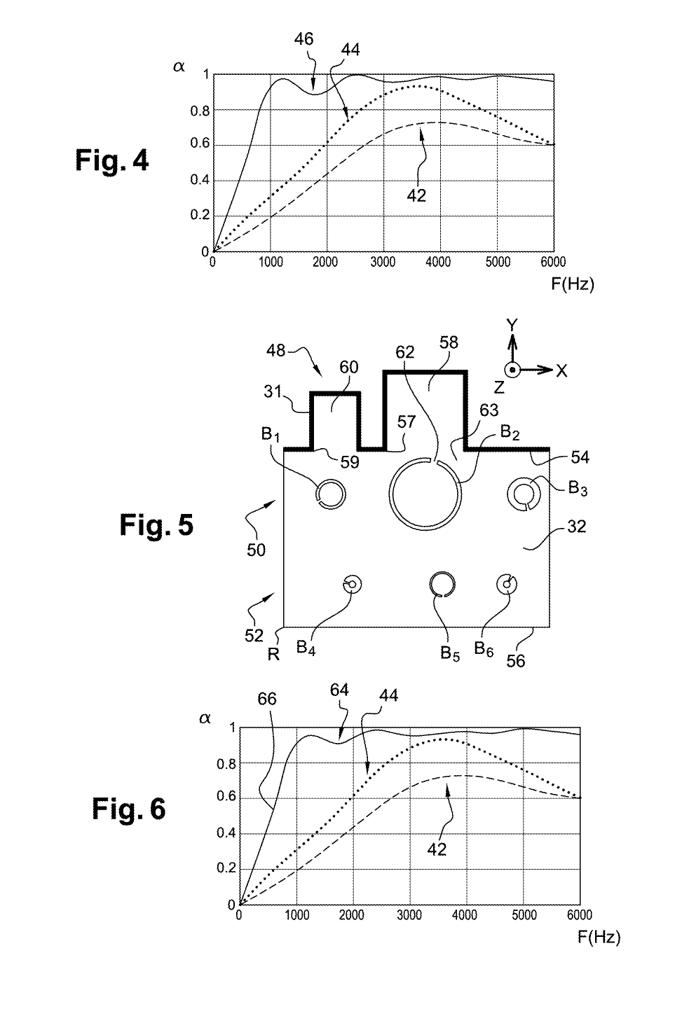

FIG. 4 is a graph showing on the Y axis the coefficient of absorption as a function of the frequency on the X axis for the cell of FIG. 1, the cell of FIG. 3 and the foam alone in which the resonator or resonators are arranged;

FIG. 5 is a schematic view in cross-section of an acoustically absorbent cell according to a second embodiment of the invention;

FIG. 6 is a graph showing on the Y axis the coefficient of absorption as a function of the frequency on the X axis for the cell of FIG. 1, the cell of FIG. 5 and the foam alone in which the resonator or resonators are arranged;

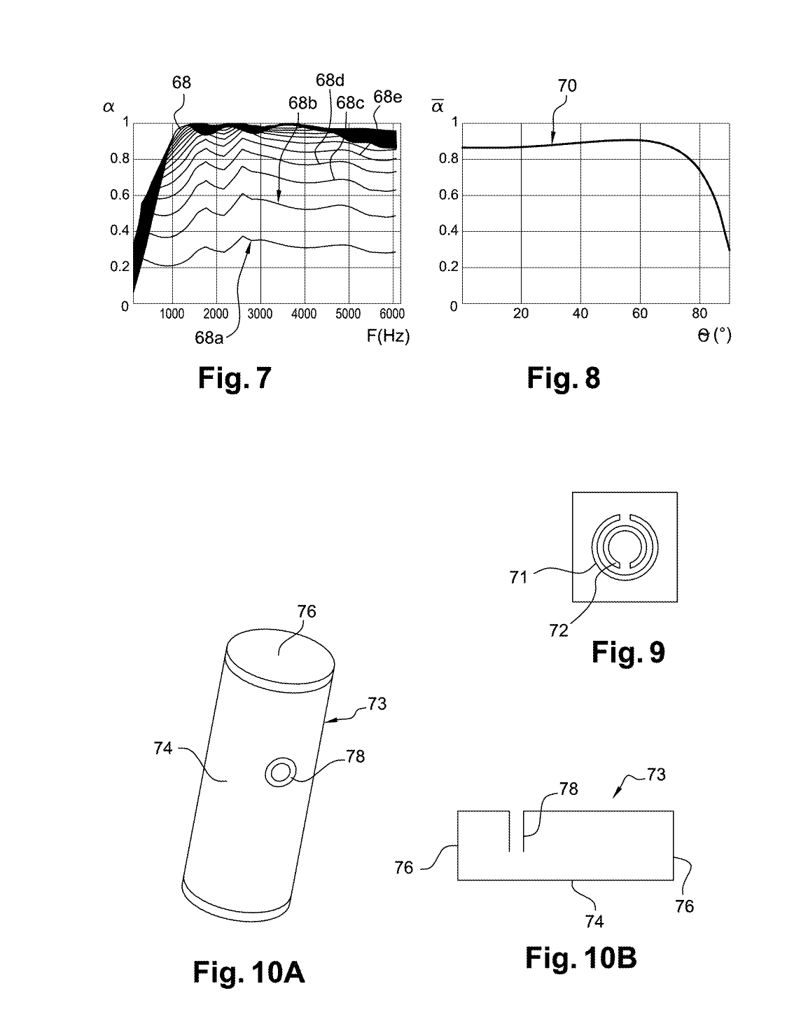

FIG. 7 is a graph showing on the Y axis the coefficient of absorption as a function of the frequency on the X axis for a plurality of values of angles of incidence;

FIG. 8 is a graph showing on the Y axis the average of the coefficients of absorption over the frequency range 100-6000 Hz as a function of the angle of incidence;

FIG. 9 depicts a schematic view in cross-section of a resonator with two split tubes inserted one inside the other;

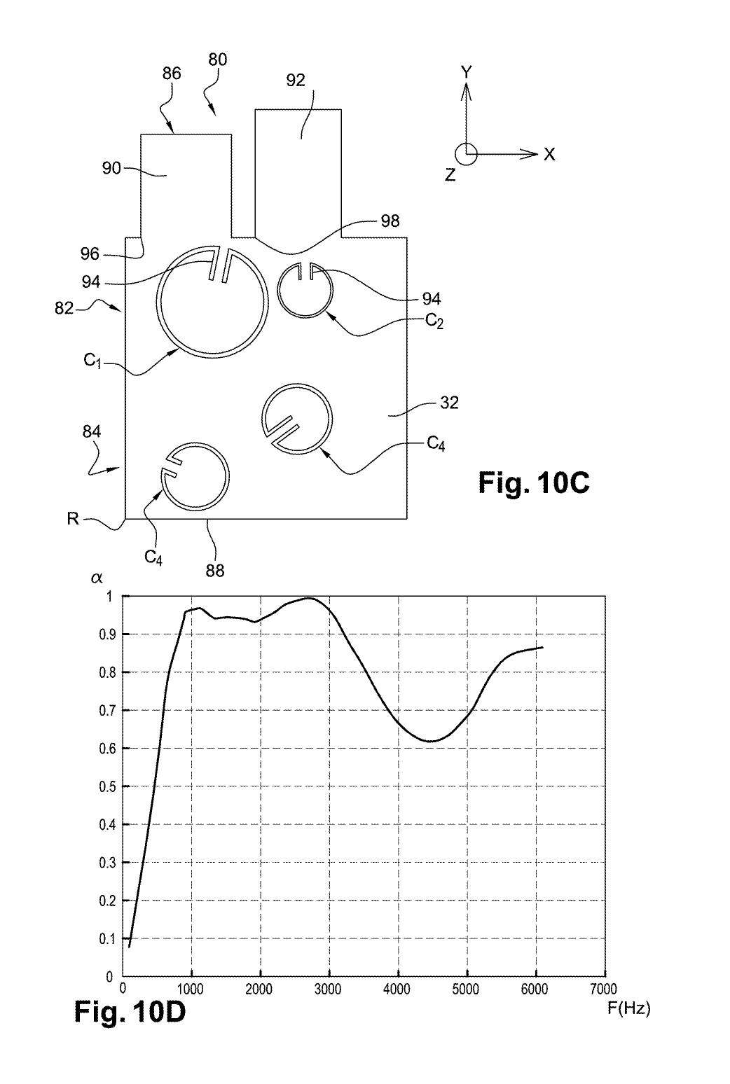

FIG. 10A is a schematic view in perspective of a resonator that can be used in a cell according to the invention;

FIG. 10B is a schematic view of FIG. 8A along a cutting plane comprising the direction of elongation of the resonator;

FIG. 10C is a schematic view in cross-section of an absorbent cell according to a third embodiment of the invention;

FIG. 10D is a graph showing on the Y axis the coefficient of absorption as a function of the frequency of the X axis for the cell of FIG. 10C;

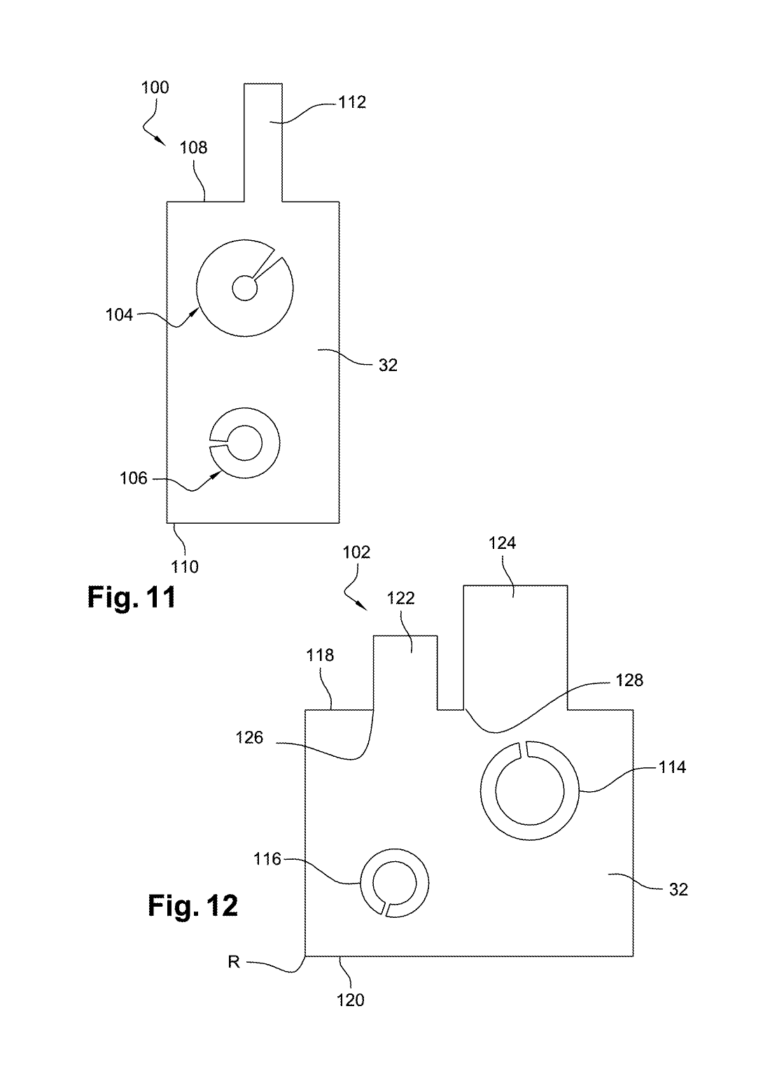

FIGS. 11 and 12 are schematic views in cross-section of two absorbent cells according to fourth and fifth embodiments of the invention;

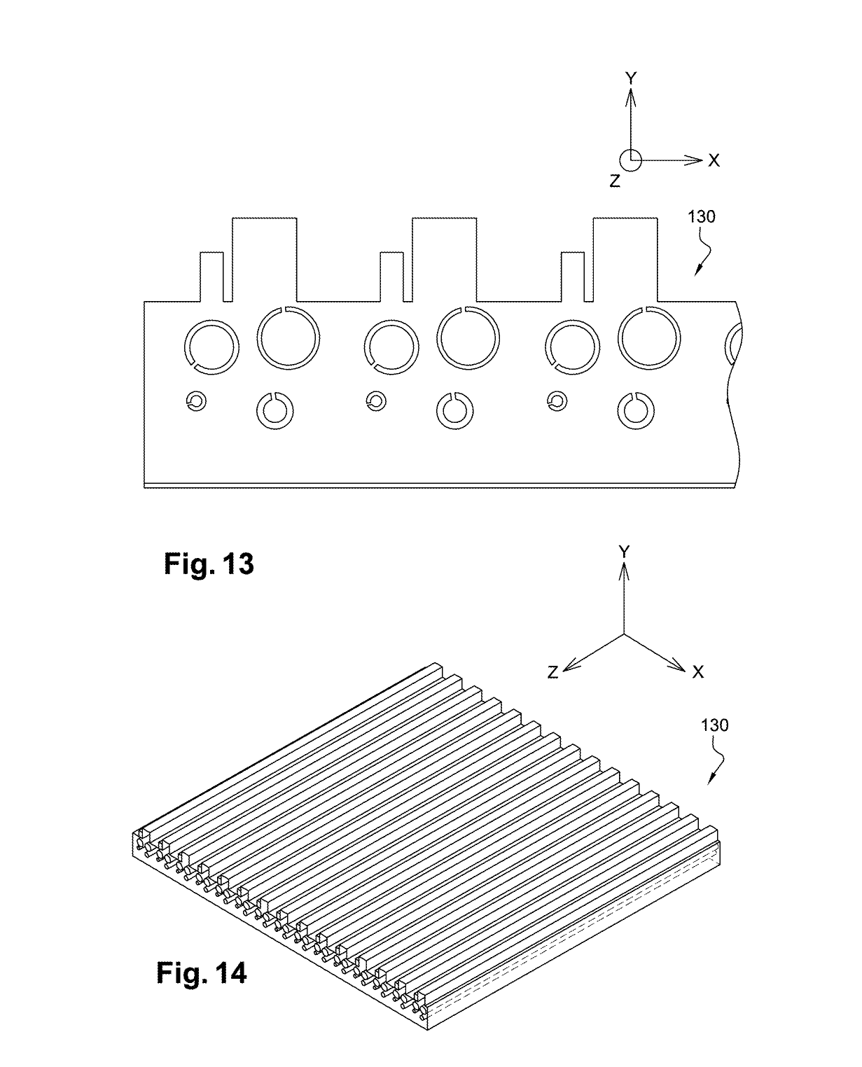

FIG. 13 is a view in cross-section of an acoustic panel according to the invention;

FIG. 14 is a schematic view in perspective of the acoustic panel of FIG. 13.

Reference is made first of all to FIG. 1, which depicts an acoustically absorbent cell 10 according to the prior art, comprising a layer 12 formed by a matrix of a porous material comprising first 14 and second 16 faces facing each other and between which an acoustic resonator 18 is arranged. The dimensions of the cell 10 are defined in the three perpendicular directions in space, in the direction X by its width I, in the direction Y by its thickness e and in the direction Z by its length L.

In the cell 10 in FIG. 1 and as depicted in FIG. 2, the acoustic resonator 18 is formed by a tube with a circular cross-section open at its two opposite ends and comprising a slot 19 extending over the entire length of the tube. The resonator 10 therefore has a shape elongate in a direction of axis Z, the resonator 10 being arranged between the first 14 and second 16 faces so that the axis Z extends along the first 14 and second 16 faces. The first face 14 is covered with a layer 20 of a material more rigid than the porous matrix. In practice, it is desirable for the Young's modulus of the layer 20 to be at least 20 GPa. This rigid layer 20 may be made from brass or aluminium, or even wood for example. The porous matrix has a Young's modulus of around few thousands of kPa, which makes it possible to provide a sufficiently great difference in impedance between the matrix and the rigid layer so as to guarantee total reflection at the acoustic waves of the interface.

It should be noted that, in the case of vibrations of the first face according to plate modes, it is possible to add a metal plate to the first face in order to limit these vibrations.

As indicated previously, though this type of cell 10 greatly increases the coefficient of absorption, this is not yet sufficiently close to unity.

To this end, the invention thus proposes an acoustically absorbent cell in which the resonators are ordered in a direction extending substantially perpendicular to the first face and the second face so that at least one first resonator is arranged between the first face and at least one second resonator is arranged between the second face and the at least one first resonator.

Thus, in a first embodiment depicted in FIG. 3, the cell 22 comprises first 24 and second 26 rows of acoustic resonators between the first 28 and second 30 faces of a layer 32 with a porous matrix. The cell 22 comprises two opposite lateral faces 34, 36 substantially parallel and perpendicular to the first face 28 and second face 30. The first row 24 is arranged, in a direction perpendicular to the first 28 and second 30 faces of the cell 22, between the first face 28 and the second row 26 of resonators, this second row 26 being arranged between the first row 24 and the second face 30 of the cell 22.

In this first embodiment, each of the first and second rows 24, 26 comprises two acoustic resonators A₁, A₂ and A₃, A₄, respectively. The resonators A₁, A₂ and A₃, A₄ used in this embodiment are split tubes as described above. The tubes A₁, A₂, A₃, A₄ thus each have an elongate shape in a direction Z extending along the first 28 and second 30 faces. The axes Z of the tubes are substantially parallel to one another in the cell 22. The first face 30 is also covered with a rigid layer as described with reference to FIG. 1.

As depicted, the resonators A₁, A₂, A₃, A₄ have dimensional parameters such that the resonators are all different in pairs. The dimensional parameters in question are the thickness of the wall of the tube and the external radius mainly. The angular opening of the slot in each ring also influences, but to a lesser extent, the resonant frequency of the resonators. By increasing the angular opening, it is possible to slightly decrease the resonant frequency. However, the larger the angular opening the greater the intensity of the resonance.

As observed in FIG. 3, the distances d1-d5 separating two resonators A₁, A₂, A₃, A₄ are all different in pairs so as to increase the destructive interferences between two given resonators A₁, A₂, A₃, A₄, increasing the coefficient of absorption of the cell accordingly.

The first face 30 of the cell is conformed so as to comprise an indentation delimiting a cavity 38 extending in a direction opposite to the second face 28 and emerging between the two first 28 and second 30 faces. As depicted in FIG. 3, the split tube A₂ in the row 24 of resonators adjacent to the first face is situated in the immediate vicinity of the cavity 38 and its opening or slot 40 emerges in the direction of the outlet of the cavity 38. This particular arrangement ensures that the assembly formed by the resonator A₂ and the cavity 38 behaves as a resonator functioning at a frequency lower than the resonant frequency of the cavity 38 and of the resonator A₂.

The cavity 38 of the first face 30 of the cell 22 extends along the axis Z substantially over the same distance as the split tube A₂.

The following table summarises the dimensional parameters of the four resonators A₁, A₂, A₃ and A₄ and their respective positionings in the cell. The angle values are measured with respect to the direction opposite to the direction of Y given in FIG. 3. The reference for the positions of the centres of the resonators is taken at R in FIG. 3.

In the following table, the values given for each column (except for the third column) are those of a parameter x (with dimension) that constitutes an input value of an equation given in the boxes of the first line in order to deduce therefrom the quantity in the column of interest.

| | | | | | Position along | Position along |
|---|---|---|---|---|---|---|
| | | | | | the axis X of the | the axis Y of the |
| | External | Thickness | Angular | Width of | centre of the | centre of the |
| | radius | of the wall | position of | the slot | resonator | resonator |
| | (R = x * E/4) | (e = 2R * x) | the slot | (L = x * R) | (Px = x * a) | (Py = x * E) |
| Resonator | 0.1 to 0.3 | 0.15 to 0.30 | 25° to 70° | 0.1 to 0.4 | 0.2 to 0.4 | 0.6 to 0.9 |
| A₁ | [0.2] | [0.25] | [30] | [0.2] | [0.27] | [0.75] |
| Resonator | 0.5 to 0.8 | 0.05 to 0.1 | 190° to 230° | 0.1 to 0.4 | 0.6 to 0.8 | 0.6 to 0.9 |
| A₂ | [0.75] | [0.07] | [195] | [0.2] | [0.65] | [0.75] |
| Resonator | 0.1 to 0.4 | 0.02 to 0.05 | −15° to 15° | 0.1 to 0.4 | 0.2 to 0.4 | 0.2 to 0.4 |
| A₃ | [0.3] | [0.03] | [−10] | [0.2] | [0.37] | [0.25] |
| Resonator | 0.1 to 0.4 | 0.15 to 0.30 | 310° to 340° | 0.1 to 0.4 | 0.7 to 0.9 | 0.2 to 0.4 |
| A₄ | [0.3] | [0.25] | [320] | [0.2] | [0.87] | [0.25] |

In each case, the value between brackets indicates a preferred value in the range of values indicated.

“E” represents the thickness of the layer of porous material. “a” represents the width of the cell in the direction X (see FIG. 3).

The following table gives the particular values of the cell depicted in FIG. 3 for the values between brackets in the previous table, the value of “E” being 40 mm and the value of “a” being 40 mm.

| | | | | | Position | Position |
|---|---|---|---|---|---|---|
| | | | | | along the | along the |
| | | | Angular | Width of | axis X of | axis Y of |
| | External | Thickness | position of | the slot | the centre of | the centre of |
| | radius | of the wall | the slot | (mm) | the resonator | the resonator |
| | (mm) | (mm) | (degrees) | (L = x * R) | (mm) | (mm) |
| Resonator A₁ | 2 | 1 | 30 | 0.4 | 11 | 30 |
| Resonator A₂ | 7.5 | 1 | 195 | 1.5 | 26 | 30 |
| Resonator A₃ | 3 | 0.2 | 275 | 0.6 | 15 | 10 |
| Resonator A₄ | 3 | 1.5 | 275 | 0.6 | 35 | 10 |

The following table summarises the dimensional parameters of the cavity 38 and the positioning of the corner 37 of the cavity. In the following table, the values given for each column (with the exception of the “position of the corner 37”, which gives a value in mm) are those of a parameter x (without dimension) which constitutes an input value of an equation given in each column of interest. The value between brackets in each case indicates a preferred value of a range of values indicated.

| | Position of | Position of | Dimension of | Dimension of |
|---|---|---|---|---|
| | the corner | the corner | the cavity | the cavity |
| | 37 in X | 37 in Y | along the axis | along the axis |
| | (Px = x*a) | (mm) | (Dx = x*a) | (Dy = x*E) |
| Cavity 38 | 0.1 to 0.6 | E | 0.1 to 0.4 | 0.1 to 0.6 |
| | [0.2] | | [0.32] | [0.27] |

The following table gives the particular values of the cavity 38 in FIG. 3 for the values between brackets in the previous table, the value of “E” being 40 mm and the value of “a” being 40 mm.

| | Position of | Position of | Dimension of | Dimension of |
|---|---|---|---|---|
| | the corner | the corner | the cavity | the cavity |
| | 37 in X | 37 in Y | along the axis X | along the axis Y |
| | (mm) | (mm) | (mm) | (mm) |
| Cavity 38 | 8 | 40 | 13 | 11 |

FIG. 4 represents the change in absorption a (without unit) on the Y axis as a function of the frequency (in Hz) on the X axis. This graph comprises three curves, a first one 42 which concerns the absorption of a porous matrix alone made from melamine, the second 44 concerns the absorption of the cell in FIG. 1 with a melamine matrix and the third 46 concerns the absorption of the cell according to the invention in FIG. 3, also with a melamine matrix.

It is clear that the coefficient of absorption with the cell in FIG. 1 (curve 44) is greater to the coefficient of absorption obtained with the porous matrix alone (curve 42). In addition, the coefficient of absorption of the curve 44 is greater than 0.8 only in a restricted range of frequencies between 2500 and 3700 Hz. Finally, for frequencies below 1700 Hz, the absorption is below 0.5. Panels based on the cells in FIG. 1 therefore are suitable for commercial use.

On the other hand, with the cell 22 according to the invention comprising two rows 24, 26 of resonators A₁, A₂, A₃, A₄, an absorption greater than 0.8 is obtained as from 1000 Hz. For higher frequencies, it is found that the coefficient of absorption a increases in order to reach a value of around 1 as from 1500 Hz, the coefficient of absorption then remaining substantially constant and around 1 up to frequencies of 6000 Hz and even beyond (not shown).

These performances are thus obtained for a cell 22 with a much reduced thickness of around 4 cm, which makes it possible to easily integrate it in an acoustic panel without significant losses of space on the ground in the case of integration on walls in a room.

FIG. 5 depicts a second embodiment of a cell 48 according to the invention, comprising two rows 50, 52 of three resonators B₁, B₂, B₃ and B₄, B₅, B₆ each. The first face 54 of the cell comprises two cavities 58, 60. Each cavity 58, 60 emerges directly in the direction of a resonator B₁, B₂, the diameter of which is substantially equal to the dimension of the cavity measured in the direction Y.

Just as with reference to FIG. 3, the opening 62 of the resonator B₂ emerges in the direction of the cavity 58 so as to create a resonant assembly (cavity 58 and resonator B₂) resonating at a lower frequency than each of the resonator B₂ and the cavity 58 in isolation.

In addition to the effect mentioned in the previous paragraph, it is clear that the arrangement of the resonator B₂ in the vicinity of the opening of the cavity 58 leads to the formation of two small openings or slots 63. These slots 63 delimit openings similar to those of a Helmholtz resonator, thus enabling the cavity 38 coupled to the openings 63 to absorb at lower frequencies than the quarter-wave frequency of the assembly formed by the cavity 58 and the resonator B₂.

The following table summarises the dimensional parameters of the six resonators B₁, B₂, B₃, B₄, B₅ and B₆ and their respective positioning in the cell. The angle values are measured with respect to the direction opposite to the direction of Y given in FIG. 5. The reference for the positions of the centres of the resonators is taken at R in FIG. 5.

In the following table, the values given for each column (except for the third column) are those of a parameter x (without dimension) that constitutes an input value of an equation given in the boxes on the first line in order to deduce therefrom the quantity in the column of interest.

| | | | | | Position | Position |
|---|---|---|---|---|---|---|
| | | | | | along the | along the |
| | | | | | axis X of | axis Y of |
| | | | | | the centre | the centre |
| | External | Thickness | Angular | Width of | of the | of the |
| | radius | of the wall | position of | the slot | resonator | resonator |
| | (R = x * E/4) | (e = 2R * x) | the slot | (L = x * R) | (Px = x * a) | (Py = x * E) |
| Resonator B₁ | 0.2 to 0.4 | 0.1 to 0.3 | 285° to 320° | 0.1 to 0.4 | 0.1 to 0.3 | 0.6 to 0.9 |
| | [0.3] | [0.13] | [300] | [0.2] | [0.17] | [0.75] |
| Resonator B₂ | 0.5 to 0.8 | 0.05 to 0.1 | 160° to 300° | 0.1 to 0.4 | 0.4 to 0.6 | 0.6 to 0.9 |
| | [0.77] | [0.07] | [165] | [0.2] | [0.5] | [0.75] |
| Resonator B₃ | 0.2 to 0.4 | 0.2 to 0.5 | 0° to 40° | 0.1 to 0.4 | 0.7 to 0.9 | 0.6 to 0.9 |
| | [0.3] | [0.25] | [20] | [0.2] | [0.88] | [0.75] |
| Resonator B₄ | 0.05 to 0.2 | 0.4 to 0.7 | 250° to 270° | 0.1 to 0.4 | 0.1 to 0.3 | 0.2 to 0.4 |
| | [0.15] | [0.6] | [255] | [0.2] | [0.27] | [0.25] |
| Resonator B₅ | 0.1 to 0.3 | 0.05 to 0.1 | −15° to 15° | 0.1 to 0.4 | 0.4 to 0.6 | 0.2 to 0.4 |
| | [0.2] | [0.05] | [0] | [0.2] | [0.58] | [0.25] |
| Resonator B₆ | 0.05 to 0.2 | 0.4 to 0.7 | 110° to 130° | 0.1 to 0.4 | 0.7 to 0.9 | 0.2 to 0.4 |
| | [0.16] | [0.6] | [120] | [0.2] | [0.77] | [0.25] |

In each box, the value between brackets indicates a preferred value in the range of values indicated. “E” represents the thickness of the layer of porous material. “a” represents the width of the cell in the direction X (see FIG. 5).

The following table gives the particular values of the cell depicted in FIG. 5 for the values between brackets in the previous table, the value of “E” being 40 mm and the value of “a” being 60 mm.

| | | | | | Position | Position |
|---|---|---|---|---|---|---|
| | | | | | along the | along the |
| | | | Angular | Width | axis X of the | axis Y of the |
| | External | Thickness | position of | of the slot | centre of the | centre of the |
| | radius | of the wall | the slot | (mm) | resonator | resonator |
| | (mm) | (mm) | (degrees) | (L = x * R) | (mm) | (mm) |
| Resonator B₁ | 3 | 0.8 | 300 | 0.6 | 10 | 30 |
| Resonator B₂ | 7.7 | 1 | 165 | 1.54 | 30 | 30 |
| Resonator B₃ | 3 | 1.5 | 20 | 0.6 | 53 | 30 |
| Resonator B₄ | 1.5 | 2 | 255 | 0.3 | 16 | 11 |
| Resonator B₅ | 2 | 0.2 | 0 | 0.4 | 35 | 11 |
| Resonator B₆ | 1.6 | 2 | 120 | 0.32 | 46 | 11 |

The following table summarises the dimensional parameters of the cavities 58, 60 and the positioning of the respective corners 59, 57 of these cavities. In the following table, the values given for each column (with the exception of the values in the columns “along Y”, which are in mm) are those of a parameter x (without dimension) that constitutes an input value of an equation given in each column of interest. The values between brackets in each box indicate a preferred value in the range of values indicated.

| | | | | | Dimen- | Dimen- |
|---|---|---|---|---|---|---|
| | | | | | sion | sion |
| | | | | | of the | of the |
| | | | | | cavity | cavity |
| | Position of the | | Position of the | | along | along |
| | corner 59 | | corner 57 | | the | the |
| | Along X | Along | Along X | Along | axis X | axis Y |
| | (Px = | Y | (Px = | Y | (Px = | (Py = |
| | x * a) | (mm) | x * a) | (mm) | x * a) | x * E) |
| Cavity | | | 0.5 to 0.8 | E | 0.4 to 0.6 | 0.4 to 0.7 |
| 58 | | | [0.57] | | [0.28] | [0.5] |
| Cavity | 0.1 to 0.4 | E | | | 0.1 to 0.4 | 0.2 to 0.4 |
| 60 | [0.2] | | | | [0.16] | [0.35] |

The following table gives the particular values of the cavities 59 and 57 in FIG. 5 for the values between brackets of the previous table, the value of “E” being 40 mm and the value of “a” being 60 mm.

| | | | | | Dimension | Dimension |
|---|---|---|---|---|---|---|
| | | | | | of the | of the |
| | Position of | | Position of | | cavity | cavity |
| | the corner | | the corner | | along | along |
| | 59 | | 57 | | the axis | the axis |
| | (mm) | | (mm) | | X | Y |
| | Along X | Along Y | Along X | Along Y | (mm) | (mm) |
| Cavity 58 | | | 23 | 40 | 17 | 20 |
| Cavity 60 | 8 | 40 | | | 10 | 14 |

The graph in FIG. 6 is a graph similar to the one in FIG. 4. The curve 64 represents the change in the absorption a as a function of frequency and the curves 42 and 44 are identical to those described with reference to FIG. 3.

It is found that the curve 64 comprises a first slope part 66 steeper than with the cell 22 of FIG. 3, demonstrating better absorption. This is because the coefficient of absorption of the cell 48 proves to be slightly greater than almost all the frequency range 0-6000 Hz than the coefficient of absorption of the cell 22.

FIG. 7 is a graph showing the change in the absorption on the Y axis as a function of frequency for the cell depicted in FIG. 5. The various curves 68 depicted each correspond to a value of an angle of incidence of acoustic waves on the cell. In particular, the curves 68a, 68b, 68c, 68d, 68e, . . . correspond to increasing angles and respectively to values of angles of 90°, 85°, 80°, 75° and 70°.

The curve 70 in FIG. 8 shows the change in the average absorption over the frequency range 0-6000 Hz as a function of the angle of incidence of acoustic waves on the second face 54 of the cell 48 depicted in FIG. 5. The coefficient of absorption varies very little as a function of the angle of incidence and remains greater than 0.8 for angles of between 0 and 75 degrees. Beyond 75 degrees, that is to say in an incidence considered to be glancing, the coefficient of absorption decreases until it reaches an average of 0.3 at 90 degrees. In the case of glancing incidence, it is probable that the acoustic wave does not enter the cell 48, or only a little, but on the contrary is reflected by the second face and the first row of resonators B₄, B₅ and B₆.

Despite this reduction in the coefficient of absorption at glancing incidence, this material may be considered to be almost omnidirectional and is completely suited to use in diffuse field for example, for buildings acoustics for example. Although not shown, a similar result is obtained for the cell 22 in FIG. 3.

The value “E” of the thickness of the porous material is advantageously between 10 and 80 mm, preferably between 20 and 50 mm and more preferentially is around 40 mm. This is because, for the latter value, it was found that, for all types of cell, such as those described previously, the absorption was between 0.58 and 0.60 on average over the frequency range 125-4000 Hz and around 0.48 over this frequency range for a porous material alone (without resonator) or a cell of FIG. 1.

“a” is advantageously between 1*E and 5*E, or between 10 and 400 mm, preferably between 20 and 160 mm and more preferentially is around 40 mm.

Other resonators may also be used instead of the tubes with a circular cross-section, such as split tubes open at their ends and with a square, rectangular, ellipsoidal or star-shaped cross-section. It is also possible to use resonators formed by two split tubes 71, 72 with a cross-section as described previously and inserted one inside the other as depicted in FIG. 9. This type of resonator makes it possible to have no resonant frequencies, but is difficult to implement.

It is also possible to use Helmholtz resonators comprising at least one tubular neck open at both ends and emerging inside a cavity of the resonator. One example of such a resonator 73 is depicted in FIGS. 10A and 10B. This comprises a tubular part 74 closed at its ends by discs 76. This type of so-called Helmholtz resonator is arranged in the same way as the tubes described with reference to FIGS. 3 and 5 with the axis of the tube extending in the direction Z.

A practical embodiment of a cell 80 with Helmholtz resonator is depicted in FIG. 10C and comprises two rows 82, 84 of two resonators C₁, C₂, C₃, C₄ between a first face 86 and a second face 88. The first face 82 of the cell 80 comprises two cavities 90, 92. The neck 94 of the resonators C₁, C₂ emerges directly in the direction of a cavity 90, 92 so as to create a resonant assembly (cavity 90 and resonator C₁ as well as cavity 92 and resonator C₂) resonating at a lower frequency than each of the resonators C₂ and the cavities 90, 92 taken in isolation.

The following table summarises the dimensional parameters of the four resonators C₁, C₂, C₃, C₄ as well as their respective positionings in the cell 80. The angle values are measured with respect to the direction opposite to the direction of Y. The reference for the positions of the centres of the resonators is taken at R in FIG. 100.

In the following table, the values given for each column (except for the third column) are those of a parameter x (without dimension) that constitutes an input value of an equation given in the boxes on the first line in order to derive therefrom the quantity for the column of interest.

| | | | | | | Position | Position |
|---|---|---|---|---|---|---|---|
| | | | | | | along the | along the |
| | | | | | | axis X of | axis Y of |
| | | Thickness | Angular | | | the centre | the centre |
| | External | of the | position | Diameter | Length | of the | of the |
| | radius | wall | of the | of neck | of neck | resonator | resonator |
| | (R = x * E/4) | (e = 2R * x) | slot | (d = x * R) | (c = x * R) | (Px = x * a) | (Py = x * E) |
| Resonator | 0.6 to 0.9 | 0.02 to 0.3 | 140° to 200° | 0.05 to 0.2 | 0.5 to 1 | 0.2 to 0.4 | 0.6 to 0.9 |
| C₁ | [0.8] | [0.05] | [165] | [0.055] | [0.8] | [0.3] | [0.75] |
| Resonator | 0.2 to 0.5 | 0.02 to 0.3 | 160° to 220° | 0.05 to 0.2 | 0.3 to 0.7 | 0.6 to 0.8 | 0.6 to 0.9 |
| C₂ | [0.4] | [0.05] | [182] | [0.12] | [0.45] | [0.63] | [0.8] |
| Resonator | 0.25 to 0.45 | 0.02 to 0.3 | 230° to 280° | 0.05 to 0.2 | 0.2 to 0.6 | 0.2 to 0.4 | 0.2 to 0.4 |
| C₃ | [0.48] | [0.05] | [255] | [0.1] | [0.27] | [0.25] | [0.25] |
| Resonator | 0.35 to 0.55 | 0.02 to 0.3 | 275° to 325° | 0.05 to 0.2 | 0.7 to 1.1 | 0.6 to 0.8 | 0.2 to 0.4 |
| C₄ | [0.5] | [0.05] | [300] | [0.1] | [0.8] | [0.6] | [0.35] |

In each box, the value between brackets indicates a preferred value in the range of values indicated. “E” represents the thickness of the layer of porous material. “a” represents the width of the cell in the direction X (see FIG. 10C).

The following table gives the particular values of the cell depicted in FIG. 10C for the values between brackets in the previous table, the value of “E” being 40 mm and the value of “a” being 40 mm.

| | | | | | | Position | Position |
|---|---|---|---|---|---|---|---|
| | | | | | | along the | along the |
| | | | Angular | | | axis X of | axis Y of |
| | | Thickness | position | | | the centre | the centre |
| | External | of the | of the | Diameter | Length | of the | of the |
| | radius | wall | slot | of neck | of neck | resonator | resonator |
| | (mm) | (mm) | (degrees) | (mm) | (mm) | (mm) | (mm) |
| Resonator C₁ | 8 | 0.8 | 165° | 0.44 | 6.5 | 12 | 30 |
| Resonator C₂ | 4 | 0.4 | 182° | 0.48 | 1.8 | 25 | 32 |
| Resonator C₃ | 4.8 | 0.48 | 255° | 0.46 | 1.3 | 10 | 10 |
| Resonator C₄ | 5 | 0.5 | 300° | 0.48 | 4 | 24 | 14 |

The following table summarises the dimensional parameters of the cavities 90, 92 and the positioning of the respective corners 96, 90 of the cavities 90, 92. In the following table, the values given for each column (with the exception of the values of the columns “along Y”, which are in mm) are those of a parameter x (without dimension) that constitutes an input value of an equation given in each column of interest. The values between brackets in each box indicate a preferred value in the range of values indicated.

| | | | | | Dimen- | Dimen- |
|---|---|---|---|---|---|---|
| | | | | | sion | sion |
| | | | | | of the | of the |
| | | | | | cavity | cavity |
| | Position of the | | Position of the | | along | along |
| | corner 96 | | corner 98 | | the | the |
| | Along X | Along | Along X | Along | axis X | axis Y |
| | (Px = | Y | (Px = | Y | (Px = | (Py = |
| | x * a) | (mm) | x * a) | (mm) | x * E) | x * E) |
| Cavity | | | 0.3 to 0.7 | E | 0.2 to 0.4 | 0.4 to 0.6 |
| 92 | | | [0.45] | | [0.3] | [0.45] |
| Cavity | 0.05 to 0.2 | E | | | 0.1 to 0.3 | 0.2 to 0.5 |
| 90 | [0.075] | | | | [0.3] | [0.38] |

The following table gives the particular values of the cavities 90, 92 of FIG. 10C for the values between brackets in the previous table, the value of “E” being 40 mm and the value of “a” being 40 mm.

| | Position | | Position | | Dimension | Dimension |
|---|---|---|---|---|---|---|
| | of the | | of the | | of the | of the |
| | corner 96 | | corner 98 | | cavity | cavity |
| | (mm) | | (mm) | | along the | along the |
| | Along | Along | Along | Along | axis X | axis Y |
| | X | Y | X | Y | (Px = x * E) | (Py = x * E) |
| Cavity 92 | | | 18 | 40 | 12 | 18 |
| Cavity 90 | 3 | 40 | | | 12 | 15 |

FIG. 10D shows the change in the absorption a (without unit) on the Y-axis as a function of the frequency (in Hz) on the X-axis. It can be seen that the absorption is greater than 0.9 as from approximately 850 Hz and up to 3000 Hz, the absorption being even greater than that obtained with the cells in FIGS. 3 and 5 over this range of frequencies. However, it is noted that, beyond 3000 Hz, the absorption drops fairly sharply.

FIGS. 11 and 12 show other embodiments of the invention in which the cell 100, 102 comprises only two acoustic resonators, which are here split tubes.

In the embodiment in FIG. 11, two resonators 104, 106 are arranged one behind the other in a direction (Y-axis) perpendicular to the first 108 and second 110 faces of the cell 100. A cavity 112 formed on the first face 108 of the cell 100.

In the embodiment in FIG. 12, a first resonator 114 is arranged, in a direction (Y-axis) perpendicular to the first face 118 and to the second face 120, between a second resonator 116 and the first face 118 of the cell, the second resonator 116 being arranged between the first resonator 114 and the second face 120 of the cell 102. The first face 118 of the cell 102 comprises two cavities 122, 124. Unlike FIG. 11, the first resonator 114 is offset along the X-axis with respect to the second resonator 116. In addition, each of the first 114 and second 116 resonators is aligned in a direction parallel to the Y-axis with a cavity of the first face. The slot or opening of the first resonator 114 emerges in the direction of the cavity 124.

The following table summarises the dimensional parameters of the two resonators D₁, D₂ as well as their respective positionings in the cell in FIG. 12. The angle values are measured with respect to the direction opposite to the positive direction of Y. The reference for the positions of the centres of the resonators is taken at R in FIG. 12.

In the following table, the values given for each column (except for the third column) are those of a parameter x (without dimension) which constitutes an input value of an equation given in the boxes on the first line in order to deduce therefrom the quantity in the column of interest.

| | | | | | Position | Position |
|---|---|---|---|---|---|---|
| | | | | | along the | along the |
| | | Thickness | Angular | | axis X of the | axis Y of the |
| | External | of the | position | Width of | centre of the | centre of the |
| | radius | wall | of the | the slot | resonator | resonator |
| | (R = x * E/4) | (e = 2R * x) | slot | (d = x * R) | (Px = x * a) | (Py = x * E) |
| Resonator D1 | 0.4 to 0.6 | 0.1 to 0.3 | −40 to 0 | 0.05 to 0.2 | 0.2 to 0.4 | 0.1 to 0.4 |
| | [0.53] | [0.22] | [-25] | [0.15] | [0.27] | [0.3] |
| Resonator D2 | 0.6 to 0.9 | 0.1 to 0.3 | 180 to 210 | 0.05 to 0.2 | 0.6 to 0.8 | 0.6 to 0.9 |
| | [0.8] | [0.23] | [195] | [0.13] | [0.67] | [0.66] |

In each box, the value between brackets indicates a preferred value of the range of values indicated. “E” represents the thickness of the layer of porous material. “a” represents the width of the cell in the direction X (see FIG. 12).

The following table gives the particular values of the cell depicted in FIG. 12 for the values between brackets in the previous table, the value of “E” being 30 mm and the value of “a” being 40 mm.

| | | | | | Position | Position |
|---|---|---|---|---|---|---|
| | | | | | along the | along the |
| | | | | | axis X of | axis Y of |
| | | Thickness | Angular | Width | the centre | the centre |
| | External | of the | position | of the | of the | of the |
| | radius | wall | of the slot | slot | resonator | resonator |
| | (mm) | (mm) | (degrees) | (mm) | (mm) | (mm) |
| Resonator | 4 | 1.6 | −25° | 0.6 | 11 | 9 |
| D1 | | | | | | |
| Resonator | 6 | 1.8 | 195° | 0.8 | 27 | 20 |
| D2 | | | | | | |

The following table summarises the dimensional parameters of the cavities 124, 122 and the positioning of the respective corners 126, 128 of these cavities. In the following table, the values given for each column (with the exception of the values in the columns “along Y”, which are in mm) are those of a parameter x (without dimension) that constitutes an input value of an equation given in each column of interest. The values between brackets in each box indicate a preferred value in the range of values indicated.

| | | | | | Dimen- | Dimen- |
|---|---|---|---|---|---|---|
| | | | | | sion | sion |
| | | | | | of the | of the |
| | Position of | | Position of | | cavity | cavity |
| | the corner | | the corner | | along | along |
| | 126 | | 128 | | the | the |
| | Along X | Along | Along X | Along | axis X | axis Y |
| | (Px = | Y | (Px = | Y | (Px = | (Py = |
| | x * a) | (mm) | x * a) | (mm) | x * E) | x * E) |
| Cavity | | | 0.6 to 0.8 | E | 0.2 to 0.4 | 0.4 to 0.6 |
| 124 | | | [0.47] | | [0.3] | [0.5] |
| Cavity | 0.2 to 0.4 | E | | | 0.1 to 0.3 | 0.2 to 0.5 |
| 122 | [0.22] | | | | [0.19] | [0.29] |

The following table gives the particular values of the cavities 122, 124 in FIG. 12 for the values between brackets in the previous table, the value of “E” being 30 mm and the value of “a” being 40 mm.

| | | | | | Dimen- | Dimen- |
|---|---|---|---|---|---|---|
| | | | | | sion | sion |
| | | | | | of the | of the |
| | Position of | | Position of | | cavity | cavity |
| | the corner | | the corner | | along the | along the |
| | 126 | | 128 | | axis X | axis Y |
| | (mm) | | (mm) | | (Px = | (Py = |
| | Along X | Along Y | Along X | Along Y | x * E) | x * E) |
| Cavity 124 | | | 19 | 40 | 12 | 15 |
| Cavity 122 | 9 | 30 | | | 7.5 | 8.7 |

The use of the resonators A₁-A₄, B₁-B₆, C1-C4, D1-D2, all different in pairs to their dimensional parameters as depicted and described with reference to FIGS. 3 and 5, makes it possible to ensure absorption of each resonator at a different resonant frequency, which makes it possible to ensure absorption of a wide range of frequencies. For this purpose, it is desirable for these various resonant frequencies to be sufficiently close to one another.

In a practical use of the cells of FIGS. 3, 5, 10C, 11 and 12 in an acoustically absorbent panel, the cells 22, 48 are arranged alongside each other so that the edges of the first faces 50, 54 of the cells are arranged facing each other and the edges of the second faces 28, 56 of the cells are arranged facing each other. FIGS. 13 and 14 depict such an acoustic panel 130 with a cell similar to that of FIG. 3, which comprises two rows of two acoustic resonators each. However, in the example in FIGS. 13 and 14, the cell comprises two cavities at its first face.

The acoustic panel thus obtained thus comprises a plurality of juxtaposed cells, for example five and preferably ten, which makes it possible to obtain the best absorption results for the various types of cell. It would also be possible to add a second thickness of cells, which would improve the absorption performances, mainly in the range 500-4000 Hz. However this requires a doubling of the thickness of the acoustic panel and this type of configuration therefore has to be reserved for specific applications, such as recording studios for example.

In the description, the term “porous matrix” designates a material with a rigid skeleton saturated with a fluid, which may be air in the case of an application in buildings. Preferentially, the saturation ratio, that is to say the ratio of the volume of fluid to the volume of liquid, must be at least 80%.

The porous matrix 32 may be formed from at least one of the following materials: melamine, polyurethane foam, glass wool, rock wool, straw, hemp, cellulose fibre, palm fibre, and coconut fibre.

The resonators A₁-A₄, B₁-B₆, C1-C4, D1-D2 may be produced from steel, plastics material, rubber or bamboo. Hollow reeds may also be used.

It should also be noted that the cavities of the cells 22, 48, 80, 100, 102 may either be filled with the same material as the rest of the porous layer or be filled with another porous material. Likewise, the cavities 38, 58, 60, 90, 92, 112, 122, 124 of the resonators 22, 48, 80, 100, 102 may be filled with the same porous material as that of the porous layer or be filled with a different porous material.

The cells 22, 48, 80, 100, 102 according to the invention are produced in two steps. The first consists of producing, in a block of porous material, a plurality of orifices, the cross-sections of which correspond to the cross-sections of the resonators, by means of a suitable cutting tool, for example mounted on a pillar drilling machine, and sampling the cores of porous material thus obtained. The resonators are next introduced into the corresponding orifices. The block of porous material is next cut to the required size of the cell by means for example of a handsaw or by water-jet cutting.

In the case where the cell 22, 48, 10C comprises at least a first and a second row of resonators each comprising at least two resonators as in the embodiments in FIGS. 3, 5 and 10C, it will be understood that the invention may be defined as an acoustically absorbent cell for an acoustic panel, comprising a layer with a porous matrix incorporating a plurality of acoustic resonators (A1-A4, B1-B6) between a first face 30, 54, 86 and a second face 28, 56, 88 of the porous matrix 32, characterised in that the resonators A₁-A₄, B₁-B₆, C1-C4 are ordered so as to form at least two substantially parallel rows each comprising at least two resonators and extending along the first and second faces. Thus a first row 24, 50, 82 is arranged between the first face 30, 54, 86 and at least two second resonators forming a second row 26, 52, 88 that is arranged between the first row 24, 50, 82 of resonators and the second face 28, 56, 88.

The invention may also relate to an acoustically absorbent cell comprising a layer with a porous matrix incorporating a plurality of acoustic resonators between a first face and a second face of the porous matrix, the dimensional characteristics of the resonators being determined so that the resonators are all different in pairs.

The invention may also relate to an acoustically absorbent cell comprising a layer with a porous matrix incorporating a plurality of acoustic resonators between a first face and a second face of the porous matrix, the first face being conformed so as to comprise at least one indentation forming a cavity extending in a direction opposite to the second face and emerging between the two first and second faces.

1. An acoustically absorbent cell (22, 48, 80, 100, 102) for an acoustic panel, comprising a layer (32) with a porous matrix incorporating a plurality of acoustic resonators (A₁-A₄, B₁-B₆, C1-C4, D1-D2) between a first face (30, 54, 86, 108, 118) and a second face (28, 56, 88, 110, 120) of the porous matrix (32), characterised in that the resonators (A1-A4, B1-B6, C1-C4, D1-D2) are ordered so that, in a direction extending substantially perpendicular to the first face (30, 54, 86, 108, 118) and the second face (28, 56, 88, 110, 120), at least one first resonator is arranged between the first face (30, 54, 86, 108, 118) and at least one second resonator is arranged between the second face (28, 56, 88, 110, 120) and the at least one first resonator.

2. A cell according to claim 1, characterised in that the dimensional characteristics of the resonators (A₁-A₄, B₁-B₆, C1-C4, D1-D2) are determined so that the resonators (A₁-A₄, B₁-B₆, C1-C4, D1-D2) are all different in pairs.

3. A cell according to claim 1, characterised in that the distances (d₁-d₅) separating two resonators (A₁-A₄, B₁-B₆, C1-C4, D1-D2) are all different in pairs.

4. A cell according to claim 1, characterised in that the first face (30, 54, 86, 108, 118) comprises a layer (31) of a rigid material having for example a Young's modulus of at least 20 GPa.

5. A cell according to claim 1, characterised in that the first face (30, 54, 86, 108, 118) is conformed so as to comprise at least one indentation (38, 58, 60) forming a cavity extending in a direction opposite to the second face (28, 56) and emerging between the first and second faces.

6. A cell according to claim 5, characterised in that the cavity or cavities (38, 58, 60) has or have a rectangular or square cross-section.

7. A cell according to claim 1, characterised in that the resonators (A₁-A₄, B₁-B₆) each comprise at least one opening making a resonant cavity of the resonator communicate with the porous matrix surrounding the resonator.

8. A cell according to claim 7, characterised in that the opening (40, 62) of at least one of said at least one first resonator (A₂, B₂) emerges in the opening of a cavity (38, 58) of the first face.

9. A cell according to claim 1, characterised in that the resonators (A₁-A₄, B₁-B₆) each have an elongate shape in a given direction extending along the first and second faces of the cell.

10. A cell according to claim 9, characterised in that the directions of elongation of the resonators (A₁-A₄, B₁-B₆) are substantially parallel to one another.

11. A cell according to claim 1, characterised in that the resonators (A₁-A₄, B₁-B₆) are chosen from one or more of the types of resonator in the group comprising split tubes open at their ends and with square, rectangular, circular, ellipsoidal or star-shaped cross-section, Helmholtz resonators comprising at least one tubular neck emerging inside a cavity of the resonator.

12. A cell according to claim 11, characterised in that the resonators (A₁-A₄, B₁-B₆) are all of the same type.

13. A cell according to claim 11, characterised in that the resonators (A₁-A₄, B₁-B₆) are all tubes with a circular cross-section, split over their entire height.

14. A cell according to claim 1, characterised in that it comprises at least two first resonators forming a first row (24, 50) arranged between the first face and at least two second resonators forming a second row (26, 52) that is arranged between the first row of resonators and the second face.

15. A cell according to claim 14, characterised in that the first row and the second row each comprise at least three resonators.

16. A cell according to claim 1, characterised in that the second face (28, 56) is substantially flat.

17. An acoustically absorbent panel, characterised in that it comprises a plurality of cells (22, 48) according to claim 1, the cells (22, 48) being arranged alongside one another so that the edges of the first faces of the cells (22, 48) are arranged facing each other and the edges of the second faces of the cells (22, 48) are arranged facing each other.

18. A panel according to claim 17, characterised in that it comprises at least five cells, preferably ten cells.
